(19) United States
(12) Patent Application Publication
(10) Pub. No.: US 2006/0126443 A1
(43) Pub. Date: Jun. 15, 2006

(54) Electric power supply mechanism on spinning indicator

(76) Inventor: Stanley Kuo, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/037,351

(22) Filed: Jan. 19, 2005

Related U.S. Application Data
(60) Provisional application No. 60/634,282, filed on Dec. 9, 2004.

(51) Int. Cl. G04B 19/06

(52) U.S. Cl. 368/232

(57) ABSTRACT

The present invention provides a spinning indicator system which comprises at least one spinning indicator and a mount of the spinning indicator. In this regards, the spinning indicator is mounted on the mount by joining the reel attached structure of the spinning indicator and the corresponding spinning reel of the mount. A plurality of circular electrodes comprises as an outer circular electrode and an inner circular electrode share the same axis with the mount. On a first face of the spinning indicator, which faces to the mount, a plurality of semi-circular electrodes are coated at the corresponding positions to the plurality of circular electrodes. A plurality of outer spring electrodes are attached to the outer semi-circular electrode as well as a plurality of inner spring electrodes are attached to the inner semi-circular electrode. After joining of the reel attached structure and the corresponding spinning reel, the contacts between these spring electrodes and the plurality circular electrodes would lead to the electrical coupling between the outer semi-circular electrode and the outer circular electrode as well as the inner semi-circular electrode and the inner circular electrode. In this regards, at least one electrical powered illumination source, electrically coupled to the circular electrodes on the mount, can be placed on the tip or a second face of the spinning indicator.

### CROSS REFERENCE TO RELATED APPLICATIONS

This application claims the benefit of U.S. Provisional Application No. 60/634,282, filed on Dec. 9, 2004, which is herein incorporated by reference for all intents and purposes.

### BACKGROUND OF THE INVENTION

1. Field of the Invention

The present invention generally relates to spinning indicator, and more particularly to electric power supply mechanism on spinning indicator.

2. Description of the Prior Art

Spinning indicators are applied to most human-machine interface instruments such as hand watches, wall clocks, car instruments, and etc. In order to read the indications in the dark, spinning indicators are usually coated or decorated with fluorescent materials at least at the tip. In addition, spinning indicators are illuminated by external light source installed on the background panel.

Please refer to FIG. 1, which illustrates a conventional watch 100 comprises a plurality of spinning indicators 110. In this regards, each tip 120 of the plurality of spinning indicators 110 is decorated with fluorescent materials that can be saw under gloomy circumstances. In addition, an illuminating source 130, such as light bulb, is placed besides a background face 140 to provide illumination under extremely dark environment.

However, the visual effect of fluorescent materials may not be good enough for some gloomy circumstances. Depending on the power level and the location arrangement, the illumination conditions provided by the illuminating source(s) may not be well at every corner that spinning indicators pointed. Therefore it is desired to supply electric power to some illumination sources on spinning indicators to improve visual effects.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

The present invention provides a spinning indicator system which comprises at least one spinning indicator and a mount of the spinning indicator. In this regards, an axis spinning structure which comprises at least one spinning reel is at the axis of the mount. Besides, a reel attached structure corresponding to the spinning reel is at the axis of the spinning indicator, too. Therefore the spinning indicator is mounted on the mount by joining the reel attached structure and the corresponding spinning reel. A plurality of circular electrodes comprises as an outer circular electrode and an inner circular electrode share the same axis with the mount. On a first face of the spinning indicator, which faces to the mount, a plurality of semi-circular electrodes are coated at the corresponding positions to the plurality of circular electrodes. Also in convenience of description, an outer semi-circular electrode is corresponding to the outer circular electrode and an inner semi-circular electrode is corresponding to the inner circular electrode. A plurality of outer spring electrodes are attached to the outer semi-circular electrode as well as a plurality of inner spring electrodes are attached to the inner semi-circular electrode. Of course, the plurality of outer spring electrodes are electrically coupled to the outer semi-circular electrode as well as the plurality of inner spring electrodes are electrically coupled to the inner semi-circular electrode. After joining of the reel attached structure and the corresponding spinning reel, the contacts between these spring electrodes and the plurality circular electrodes would lead to the electrical coupling between the outer semi-circular electrode and the outer circular electrode as well as the inner semi-circular electrode and the inner circular electrode. In this regards, at least one electrical powered illumination source, electrically coupled to the circular electrodes on the mount, can be placed on the tip or a second face of the spinning indicator.

### BREIF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a diagram illustrates a conventional watch;

FIGS. 2A, 2B, and 2C are diagrams depict a spinning indicator system in accordance with an embodiment of the present invention;

FIGS. 2D, 2E, and 2F are diagrams show illumination pin examples of the embodiment shown in FIG. 2A;

FIG. 3 is a diagram shows a wall clock in accordance with an embodiment of the present invention; and

FIGS. 4A and 4B are diagrams depict an illumination spinning indicator system in accordance with an embodiment of the present invention.

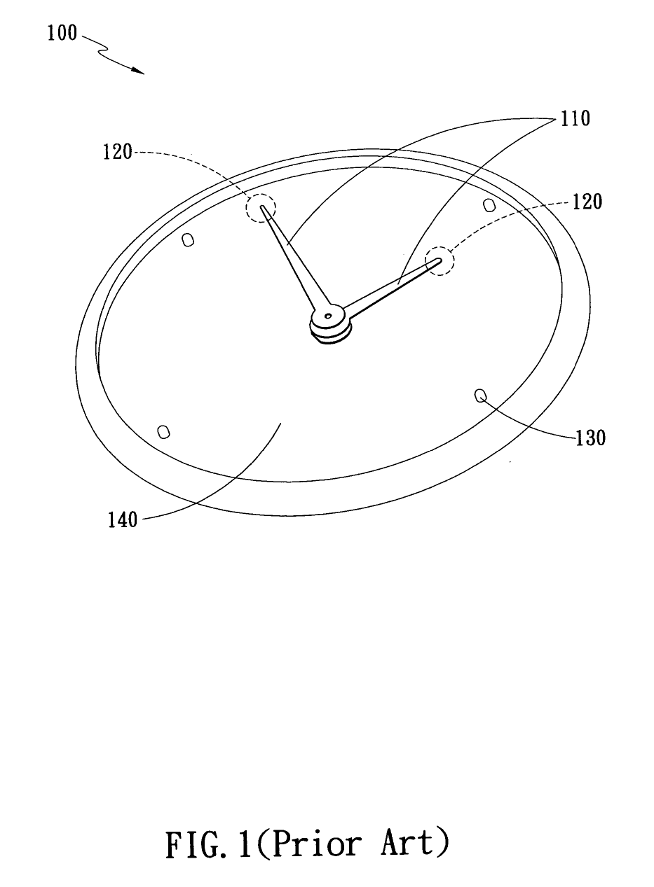

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

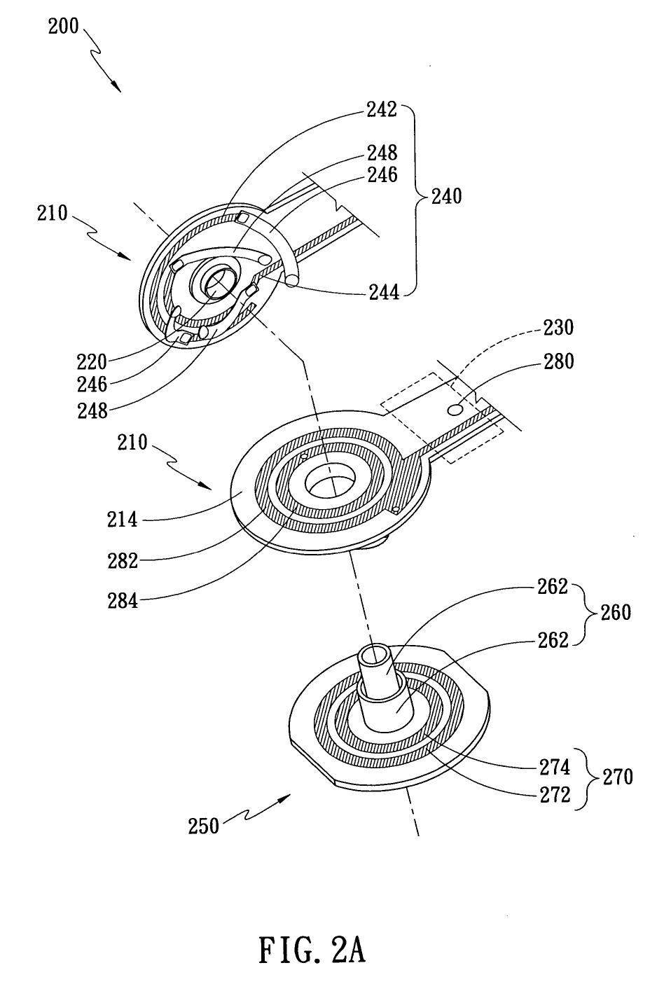

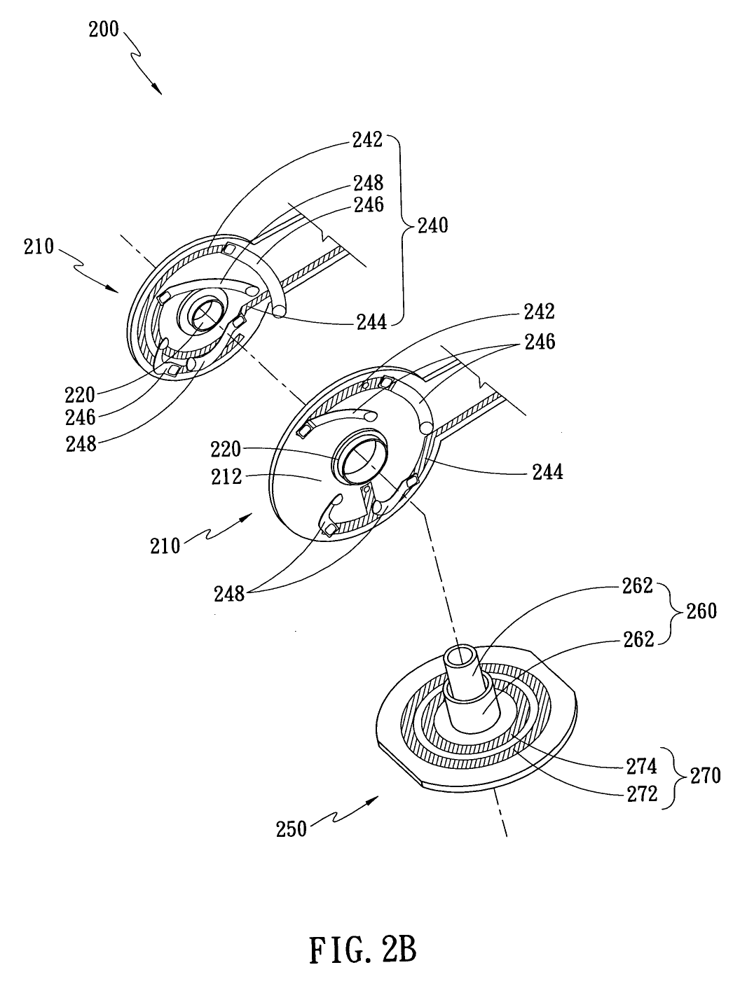

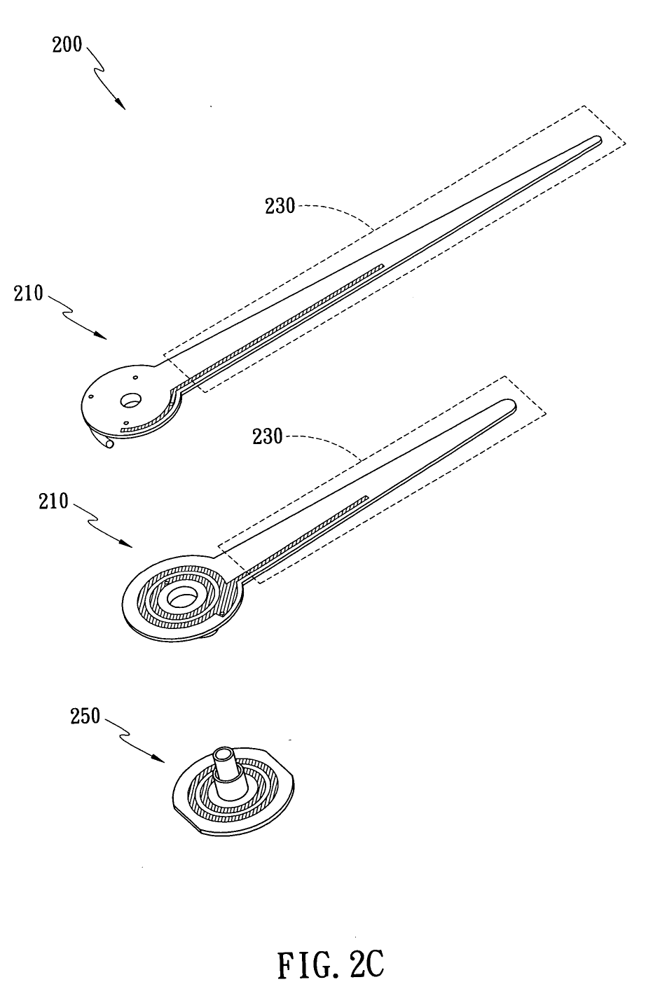

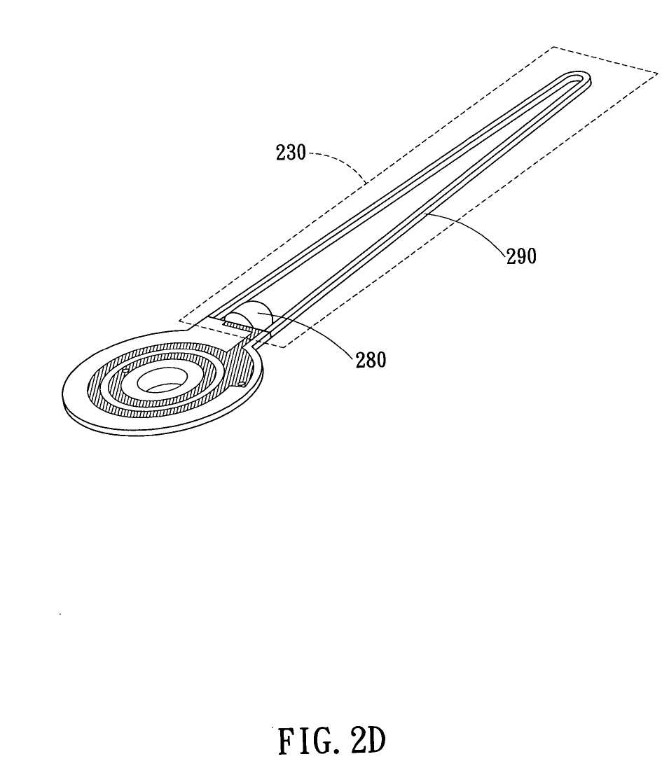

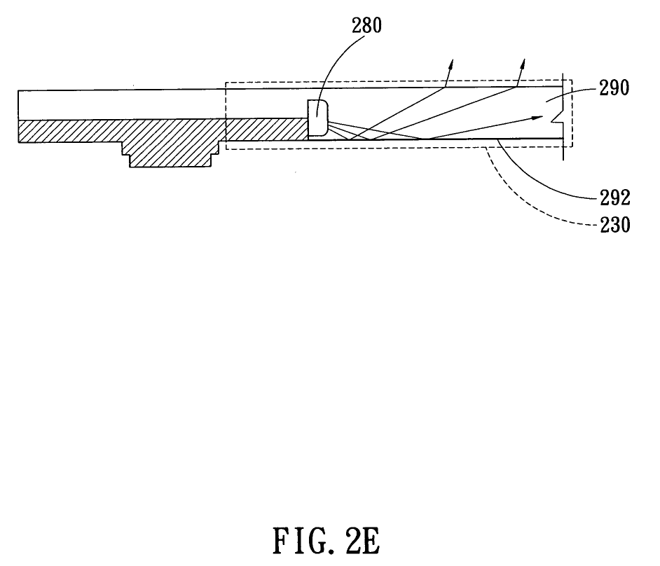

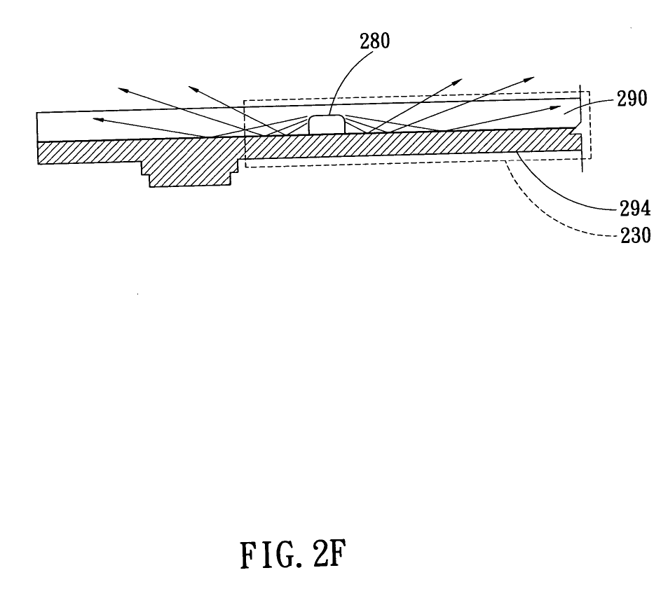

Please refer to FIGS. 2A, 2B, and 2C, which depict a spinning indicator system 200 in accordance with an embodiment of the present invention. The spinning indicator system 200 comprises at least one spinning indicator 210 and a mount 250 of the spinning indicator 210. In this regards, an axis spinning structure 260 which comprises at least one spinning reel 262 is at the axis of the mount 250. Besides, a reel attached structure 220 corresponding to the spinning reel 262 is at the axis of the spinning indicator 210, too. Therefore the spinning indicator 210 is mounted on the mount 250 by joining the reel attached structure 220 and the corresponding spinning reel 262.

In another example of this embodiment, the spinning indicator system 200 comprises a plurality of spinning indicators 210 as well as the axis spinning structure 260 comprises a plurality of spinning reels 262 shared the same axis of the mount 250. In other words, a spinning reel 262 is coaxed inside another spinning reel 262 although the rotation directions of the spinning reels 262 are not required the same. Each spinning indicator 210 is attached to its corresponding spinning reel 262.

As shown in FIGS. 2A, 2B, and 2C, the spinning indicator 210 comprises at least one pin 230. The present embodiment does not restrict only one pin 230 for one spinning indicator 210. A plurality of pins 230 are allowed for a spinning indicator 210 in accordance with the present invention.

In this regards, a plurality of circular electrodes 270 are coated on the mount 250. In convenience of description, the plurality of circular electrodes 270 is shown as an outer circular electrode 272 and an inner circular electrode 274 in the FIG. 2. The plurality of circular electrodes 270 shares the same axis with the mount 250. On a first face 212 of the spinning indicator 210, which faces to the mount, a plurality of semi-circular electrodes 240 are coated at the corresponding positions to the plurality of circular electrodes 270. Also in convenience of description, an outer semi-circular electrode 242 is corresponding to the outer circular electrode 272 and an inner semi-circular electrode 244 is corresponding to the inner circular electrode 274.

As shown in FIGS. 2A, 2B, and 2C, a plurality of outer spring electrodes 246 are attached to the outer semi-circular electrode 242 as well as a plurality of inner spring electrodes 248 are attached to the inner semi-circular electrode 244. Of course, the plurality of outer spring electrodes 246 are electrically coupled to the outer semi-circular electrode 242 as well as the plurality of inner spring electrodes 248 are electrically coupled to the inner semi-circular electrode 244. Considering the total weight and the gravity center of the spinning indicator 210, the spring force and the locations of these spring electrodes 246 and 248 are well-arranged to support the spinning indicator 210 on the mount 250. It seemed quite difficult to keep the spinning indicators 210 in balance with one only spring electrode. After joining of the reel attached structure 220 and the corresponding spinning reel 262, the contacts between these spring electrodes 246 and 248 and the plurality circular electrodes 270 would lead to the electrical coupling between the outer semi-circular electrode 242 and the outer circular electrode 272 as well as the inner semi-circular electrode 244 and the inner circular electrode 274.

In another example of the embodiment, the plurality of outer spring electrodes 246 can be attached to the outer circular electrode 272 as well as the plurality of inner spring electrodes 248 are attached to the inner circular electrode 274. Or in another example of the embodiment, the plurality of outer spring electrodes 246 can be attached to the outer circular electrode 272 as well as the plurality of inner spring electrodes 248 are attached to the inner semi-circular electrode 244, or vice versa.

As shown in FIGS. 2A, 2B, and 2C, in order to supply electric power to another upper spinning indicator 210, an outer circular electrode 282 and an inner circular electrode 284 are placed at a second face 214 opposite to the first face 212. The outer circular electrode 282 is electrically coupled to the outer semi-circular electrode 242 by at least one vertical electric trench penetrating the spinning indicator 210. Similarly, the inner circular electrode 284 is electrically coupled to the inner semi-circular electrode 244 by at least one vertical electric trench penetrating the spinning indicator 210.

In this regards, at least one electrical powered illumination source 280 can be placed on the tip or the second face 214 of the spinning indicator 210. The electrical powered illumination source 280 is electrically coupled to the semi-circular electrodes 242 and 244. In present invention, the electrical powered illumination source 280 may be light-weighted LED (Light-Emitting Diode) or bulbs with lazy air. By the way, the spinning indicator 210 may be made by PCB (Printed Circuit Board).

Please refer to FIG. 2D, which shows an illumination pin example of the embodiment shown in FIG. 2A. In this regards, an electrical powered illumination source 280 is placed at the end of the pin 230 closed near the axis. Besides, a light guidance material 290 is surrounding the edge of the pin 230. In case the electrical powered illumination source 280 is turned on, light would be rayed into the both ends of the light guidance material 290. Hence, the light is traveled and leaked along the light guidance material 290. Accordingly, the illuminated edge of the pin 230 would be seeing in the dark.

Please refer to FIG. 2E, which shows another illumination pin example of the embodiment shown in FIG. 2A. In this regards, an electrical powered illumination source 280 is placed at the end of the pin 230 closed near the axis, too. Besides, the pin 230 is made by a light guidance material 290 which comprises a light reflection coating or foil 292 of the bottom side of the pin 230. In case the electrical powered illumination source 280 is turned on, some portion of light would be leaked from the top side of the pin 230, and some portion of light would be reflected by the light reflection coating or foil 292. Accordingly, the whole illuminated pin 230 could be seeing in the dark.

Please refer to FIG. 2F, which shows another illumination pin example of the embodiment shown in FIG. 2A. In this regards, an electrical powered illumination source 280 is placed at the end of the pin 230 closed near the axis, too. The bottom side of the pin 230 is made by a non-transparent material 294 painted with any desired color and patterns. Besides, a light guidance material 290 is positioned on the top side of the pin 230. In case the electrical powered illumination source 280 is turned on, some portion of light would be leaked from the light guidance material 290, and some portion of light would be reflected by the non-transparent material 294. Accordingly, the whole illuminated pin 230 with the desired color and patterns could be seeing in the dark.

In these three examples shown in the FIGS. 2D, 2E, and 2F, the electrical powered illumination source 280 is placed at the end of the pin 230 closed near the axis. Since the provided driving torque of the spinning indicator 210 may be quite limited in practical implementations, it is important to place the “heavy” electrical powered illumination source 280 near the axis to minimize the required driving torque. In addition, the material of the pin 230 is quite thin and long in some implementations. Consequently, it implies that the structure strength of the pin 230 may not withstand the weight of electrical powered illumination source 280 at the tip of the pin 230.

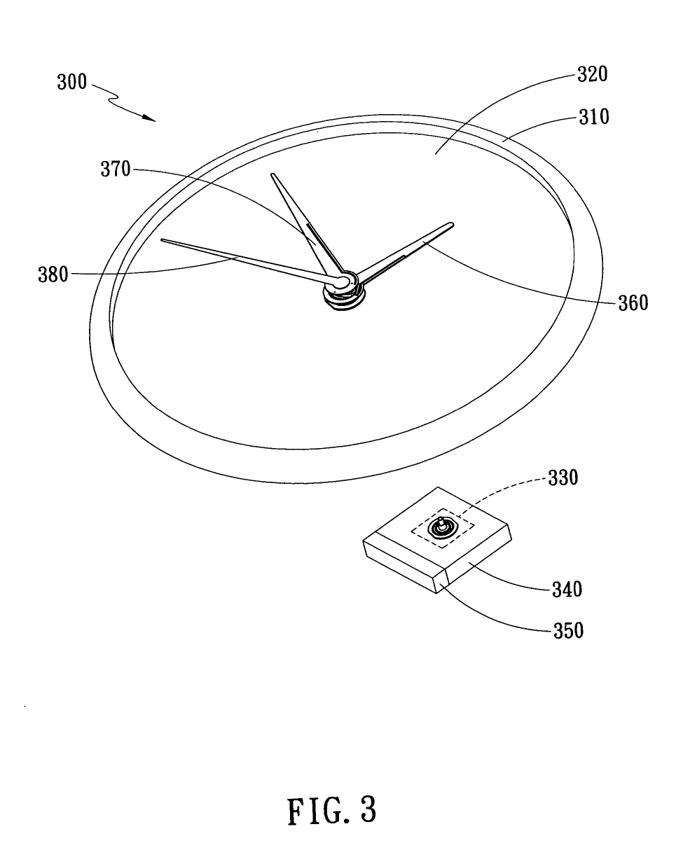

Please refer to FIG. 3, which illustrates a wall clock 300 in accordance with an embodiment of the present invention. In this regards, the wall clock 300 comprises a case 310, a clock face 320, a mount 330 on a timing mechanism 340 beneath the clock face 320, and a power module 350. Above the clock face 320, at least an hour hand 360 and a minute hand 370 are mounted on the mount 330. In addition, a sweep hand 380 may be also mounted, too.

In this regards, the timing mechanism 340 is powered by the power module 350. And the mount 330 driven by the timing mechanism 340 is swirling the hands 360, 370, and 380 at the same axis. Besides, each of the hands 360, 370, and 380 is decorated by at least one electrical powered illumination source.

All the hands 360, 370, and 380 are made as the spinning indicator 210 as shown in the FIGS. 2A, 2B, and 2C. In additional to the swirling functions, the mount 330 is also performing the same functions as the mount 250 in the FIGS. 2A, 2B, and 2C. Hence the electrical powered illumination sources will be lighted by the electric power supplied by the power module 350.

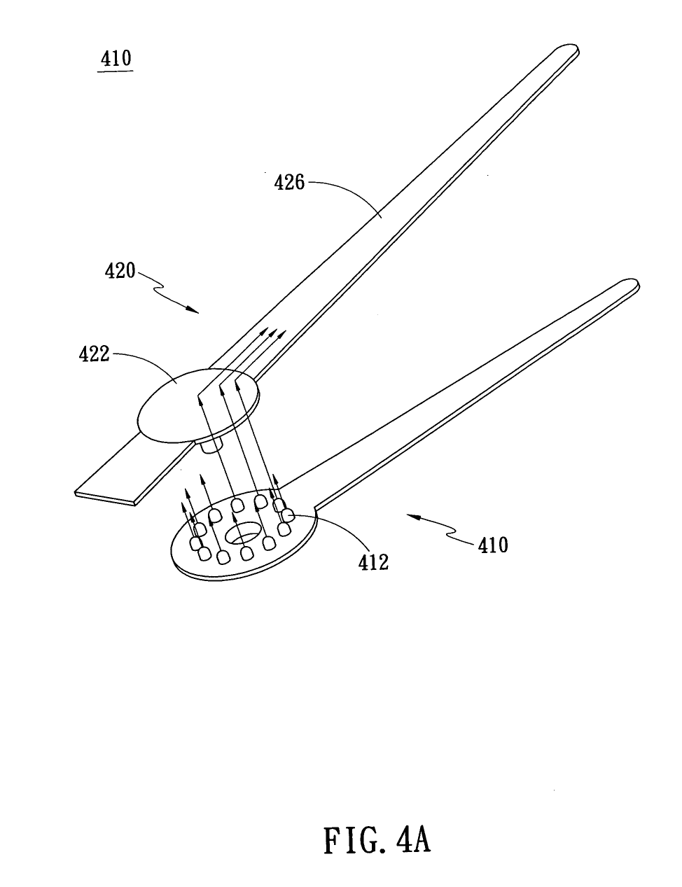

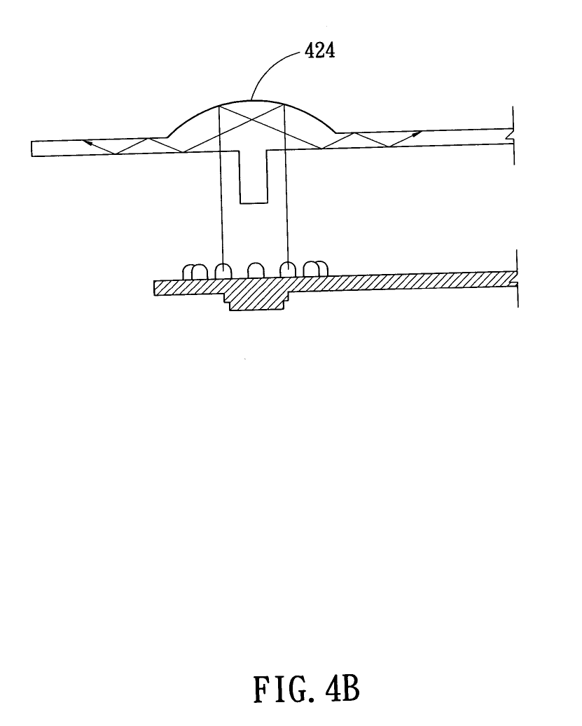

Please refer to FIGS. 4A and 4B, which depicts an illumination spinning indicator system 400 in accordance with an embodiment of the present invention. In this regards, the system 400 comprises at least an electric powered spinning indicator 410 and a reflective illumination spinning indicator 420 on top of the electric powered spinning indicator 410. Surrounding the axis, the electric powered spinning indicator 410 comprises a plurality of illumination sources 412 which may illuminates different colors. According to the embodiment of the FIG. 2A, the plurality of illumination sources 412 could be powered by the electric powered spinning indicator 410 which is in accordance with the embodiment of the FIG. 2A.

As shown in FIG. 4B, the reflective illumination spinning indicator 420 comprises a circular bulge 422 which further comprises a reflective coating or foil 424 on the top surface. Besides, the reflective illumination spinning indicator 420 also comprises at least one pin 426 to indicate. In addition, the pin 426 may be made of a light guidance material 428. Accordingly, the light emitted by the plurality of illumination sources 412 would be reflected by the reflective coating or foil 424 and traveled along the light guidance material 428. Hence, the whole pin 426 is illuminated by the plurality of illumination sources 412 of the underlying electric powered spinning indicator 410.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A system with electric power supplied spinning indicators, comprising:
a mount which comprises an axis spinning structure with an spinning reel, a plurality of circular electrodes are coated on said mount;
a spinning indicator which comprises an electrical powered illumination source and a reel attached structure corresponding to said spinning reel, a plurality of semi-circular electrodes, corresponding and electrical coupling to said plurality of circular electrodes, are coated on a first face of said spinning indicator which faces to said mount; and
a plurality of spring electrodes, said plurality of circular electrodes and said plurality of semi-circular electrodes are contacted and electrical coupled by both ends of said plurality of spring electrodes.

2. A system of claim 1, wherein said plurality of circular electrodes further comprise an outer circular electrode and an inner circular electrode.

3. A system of claim 2, wherein said plurality of semi-circular electrodes further comprise an outer semi-circular electrode and an inner semi-circular electrode.

4. A system of claim 3, wherein said plurality of spring electrodes further comprise a plurality of outer spring electrodes and a plurality of inner spring electrodes, said outer semi-circular electrode is electrical coupled to said outer circular electrode by contacting of said plurality of outer spring electrodes, said inner semi-circular electrode is electrical coupled to said inner circular electrode by contacting of said plurality of inner spring electrodes.

5. A system of claim 4, wherein said plurality of outer spring electrodes are two spring electrodes.

6. A system of claim 4, wherein said plurality of inner spring electrodes are two spring electrodes.

7. A system of claim 1, wherein said plurality of spring electrodes is attached to said plurality of semi-circular electrodes.

8. A system of claim 1, wherein said plurality of spring electrodes is attached to said plurality of circular electrodes.

9. A system of claim 4, wherein a plurality of second circular electrodes is coated on a second face which opposites to said first face of said spinning indicator.

10. A system of claim 9, wherein said plurality of second circular electrodes further comprises a second outer circular electrodes and a second inner circular electrodes.

11. A system of claim 9, wherein said mount comprises a second axis spinning with a second spinning reel, said system further comprises a second spinning indicator above said spinning indicator and a plurality of second spring electrodes, said second spinning indicator further comprises a second electrical powered illumination source and a second reel attached structure corresponding to said second spinning reel, a plurality of second semi-circular electrodes, corresponding and electrical coupling to said second plurality of circular electrodes, are coated on a third face of said second spinning indicator which faces to said spinning indicator, said plurality of second circular electrodes and said plurality of second semi-circular electrodes are contacted and electrical coupled by both ends of said plurality of second spring electrodes.

12. A system of claim 1, wherein a light guidance material is surrounding the edge of said spinning indicator and said electrical powered illumination source is placed at the end of said spinning indicator near the axis.

13. A system of claim 1, wherein said spinning indicator is made by a light guidance material which comprises a light reflection coating or foil of said first face of said spinning indicator, and said electrical powered illumination source is placed at the end of said spinning indicator near the axis.

14. A system of claim 1, wherein said spinning indicator is made by a light guidance material which comprises a non-transparent material painted with any desired color and patterns on said first face of said spinning indicator, and said electrical powered illumination source is placed at the end of said spinning indicator near the axis.

15. A system of claim 1, wherein said electrical powered illumination source is light emitting diode.

16. A system of claim 1, wherein said spinning indicator is made by printed circuit board.

17. A system of claim 1, wherein said mount comprises a second axis spinning structure with a second spinning reel, said spinning indicator comprises a plurality of illumination sources surrounding said axis reel, said system further comprises a second spinning indicator which comprises a second reel attached structure corresponding to said second spinning reel and a circular bulge opposites to said second reel attached structure, said circular bulge comprises a reflective coating or foil, said second spinning indicator is made by a light guidance material.

18. A system of claim 9, wherein said second axis reel is inside of said axis reel.

19. A system of claim 17, wherein said second axis reel is inside of said axis reel.

20. A system of claim 9, wherein said system is a clock, said spinning indicator is an hour-hand, said second spinning indicator is an minute-hand.
